(19) United States
(12) Patent Application Publication
(10) Pub. No.: US 2020/0331177 A1
(43) Pub. Date: Oct. 22, 2020

(54) FORMABLE RESIN SHEET, SHAPED ARTICLE, METHOD FOR MANUFACTURING SHAPED ARTICLE, AND PRODUCT

(71) Applicant: CASIO COMPUTER CO., LTD., Shibuya-ku, Tokyo (JP)

(72) Inventors: Hideki TAKAHASHI, Ome-shi, Tokyo (JP); Yuji HORIUCHI, Higashiyamato-shi, Tokyo (JP); Yoshimune MOTOYANAGI, Hamura-shi, Tokyo (JP); Satoshi MITSUI, Nerima-ku, Tokyo (JP)

(73) Assignee: CASIO COMPUTER CO., LTD., Shibuya-ku, Tokyo (JP)

(21) Appl. No.: 16/958,263

(22) PCT Filed: Dec. 20, 2018
(86) PCT No.: PCT/JP2018/047020

§ 371 Date: Jun. 26, 2020

(30) Foreign Application Priority Data
Dec. 28, 2017 (JP) 2017-254740
Dec. 18, 2018 (JP) 2018-236129

(51) Int. Cl. B29C 44/24; B29C 59/02; B32B 3/28; B32B 5/18; B29C 35/08

(52) U.S. Cl. CPC B29C 44/24; B29C 59/022; B29L 2031/3443; B32B 5/18; B29C 35/0805; B32B 3/28

(57) ABSTRACT

A formable resin sheet includes a base and a thermally expansive layer that contains a thermally expandable material and is formed on one surface of the base. When the thermally expansive layer is expanded, the base is deformed with expansion of the thermally expansive layer, such that the base is deformed in an embossed shape, and a deformation amount of the base is greater than an expansion height of the thermally expansive layer.

### TECHNICAL FIELD

The present disclosure relates to a formable resin sheet using a thermally expandable material that foams and distends in accordance with an amount of absorbed heat, a shaped article using the same, a method for manufacturing a shaped article, and a product.

### BACKGROUND ART

Conventionally, a switch such as a membrane switch is used as an inputter of an electronic device that is used for input of a numeral or the like. For example, an embossed resin sheet is used for the membrane switch. Also, in embossing, a resin sheet is formed into a desired shape using a concave mold and a convex mold (for example, refer to Patent Literature 1).

### CITATION LIST

### Patent Literature

Patent Literature 1: Unexamined Japanese Patent Application Publication No. H06-8254

### SUMMARY OF INVENTION

### Technical Problem

In such a method, before molding a resin sheet, there is need to prepare a mold in accordance with a shape into which the resin sheet is to be formed. For this reason, there is a problem in that the techniques of Patent Literature 1 require cost and time for fabrication of the mold.

Accordingly, a technique for easily molding a resin sheet is demanded.

The present disclosure is developed in consideration of the aforementioned circumstances, and an objective of the present disclosure is to provide a formable resin sheet that can be easily formed, a shaped article using the same, a method for manufacturing the shaped article, and a product.

### Solution to Problem

In order to attain the aforementioned objective, a formable resin sheet according to a first aspect, which is a formable resin sheet, includes a thermally expansive layer that contains a thermally expandable material and is formed on one surface of a base, is characterized in that, when the thermally expansive layer is distended, the base is deformed with the expansion of the thermally expansive layer, the base is deformed in an embossed shape, and a deformation amount of the base is greater than an expansion height of the thermally expansive layer.

In order to attain the aforementioned objective, a method for manufacturing a shaped article according to a second aspect is characterized by including (i) a step of forming, on at least one surface of a formable resin sheet, a thermal conversion layer to convert an electromagnetic wave into heat by using the formable resin sheet including a thermally expansive layer that contains a thermally expandable material and is formed on one surface of a base, and (ii) a step of emitting the electromagnetic wave to the thermal conversion layer to distend the thermally expansive layer, wherein, when the thermally expansive layer is distended, the base is deformed with the expansion of the thermally expansive layer, the base is deformed in an embossed shape, and an deformation amount of the base is made to become greater than an expansion height of the thermally expansive layer.

In order to attain the aforementioned objective, a shaped article according to a third aspect is characterized by including a thermally expansive layer that contains a thermally expandable material and is formed on one surface of a base, wherein at least a portion of the thermally expansive layer is distended, an area of the base in which the thermally expansive layer is distended is formed into an embossed shape, and a deformation amount of the area of the base is greater than an expansion height of the thermally expansive layer.

In order to attain the aforementioned objective, a product according to a fourth aspect is characterized by including the shaped article according to the third aspect.

### Advantageous Effects of Invention

According to the present disclosure, the formable resin sheet that can be easily formed, the shaped article using the same, the method for manufacturing the shaped article, and the product can be provided.

### BRIEF DESCRIPTION OF DRAWINGS

FIG. 1 is a schematic cross-sectional view of a formable resin sheet according to Embodiment 1;

FIG. 2A is a cross-sectional view illustrating a method for manufacturing the formable resin sheet according to Embodiment 1;

FIG. 2B is a cross-sectional view illustrating a method for manufacturing the formable resin sheet according to Embodiment 1;

FIG. 3 is a schematic cross-sectional view of a shaped article according to Embodiment 1;

FIG. 4 is a schematic cross-sectional view of the shaped article according to Embodiment 1;

FIG. 5 is a schematic plan view of an electronic device according to Embodiment 1;

FIG. 6 is a cross-sectional view taken along the VI-VI line illustrated in FIG. 5;

FIG. 7 is a schematic view of a printing device used for the method for manufacturing the shaped article according to Embodiment 1;

FIG. 8 is a schematic view of an expansion device used for the method for manufacturing the shaped article according to Embodiment 1;

FIG. 9 is a flowchart illustrating the method for manufacturing the shaped article according to Embodiment 1;

FIG. 10A is a cross-sectional view schematically illustrating the method for manufacturing the shaped article according to Embodiment 1;

FIG. 10B is a cross-sectional view schematically illustrating the method for manufacturing the shaped article according to Embodiment 1;

FIG. 10C is a cross-sectional view schematically illustrating the method for manufacturing the shaped article according to Embodiment 1;

FIG. 11 is a schematic view of a modified example of Embodiment 1;

FIG. 12 is a schematic view of a modified example of Embodiment 1;

FIG. 13 is a schematic cross-sectional view of a sticker according to Embodiment 2;

FIG. 14A is a schematic perspective view of a lighting device according to Embodiment 3;

FIG. 14B is a cross-sectional view of an area of a lampshade surrounded by a dashed line illustrated in FIG. 14A;

FIG. 14C is a cross-sectional view of a modified example of the lampshade;

FIG. 15 is a schematic cross-sectional view of a switch according to Embodiment 4;

FIG. 16 is a flowchart illustrating a method for manufacturing a shaped article according to Embodiment 4;

FIG. 17A is a cross-sectional view schematically illustrating the method for manufacturing the shaped article according to Embodiment 4;

FIG. 17B is a cross-sectional view schematically illustrating the method for manufacturing the shaped article according to Embodiment 4;

FIG. 17C is a cross-sectional view schematically illustrating the method for manufacturing the shaped article according to Embodiment 4;

FIG. 17D is a cross-sectional view schematically illustrating the method for manufacturing the shaped article according to Embodiment 4;

FIG. 17E is a cross-sectional view schematically illustrating the method for manufacturing the shaped article according to Embodiment 4;

FIG. 18A is a schematic cross-sectional view of a formable resin sheet according to Embodiment 5;

FIG. 18B is a schematic cross-sectional view of the formed formable resin sheet according to Embodiment 5;

FIG. 18C is a schematic cross-sectional view of a shaped article according to Embodiment 5; and

FIG. 18D is a schematic cross-sectional view of a modified example of Embodiment 5.

### DESCRIPTION OF EMBODIMENTS

Embodiments of a formable resin sheet, a shaped article using the same, a method for manufacturing the shaped article, and a product are described below in detail with reference to the drawings.

In the present embodiment, a shaped article is produced by forming a formable resin sheet with a protuberance on a thermal expansive layer. In the present disclosure, the term “shaped object” widely means (i) objects having shapes such as simple shapes and geometrical shapes, (ii) characters, (iii) decorations, and the like. The term “decorations” refers to objects that evoke the aesthetic sense through visual and/or tactile sensation. The term “shaped (or formed)” does not only merely mean the forming of a shaped object but also includes concepts such as decoration by adding decorations and ornamentation by forming decorations. Additionally, the term “decorative shaped article” means shaped articles formed as a result of decoration or ornamentation.

The shaped article of the present embodiment includes protuberances protruding in a direction perpendicular to a particular two-dimensional plane (for example, X-Y plane) in the three-dimensional space, that is, for example, in the Z-axis direction. Such a shaped article is one example of three-dimensional (3D) images and is referred to as a 2.5-dimensional (2.5D) image or a pseudo-three-dimensional (pseudo-3D) image in order to distinguish the shaped article from three-dimensional images formed using so-called 3D printing. Also, a technique used to produce the shaped article is one example of three-dimensional image printing techniques and is referred to as 2.5D printing or pseudo-three-dimensional (pseudo-3D) printing in order to distinguish such a technique from so-called 3D printing.

Also, in the embodiments described later, the term “formable resin sheet” means a sheet that is not yet subjected to a molding process. Also, the “shaped article” is obtained by molding the formable resin sheet. In addition, an article provided with the shaped article of the present embodiment is referred to as a “product”.

### Embodiment 1

Formable Resin Sheet 10

As illustrated in FIG. 1, a formable resin sheet 10 includes a base 11 and a thermally expansive layer 12 provided on one side of the base 11. As described later in detail, in the formable resin sheet 10, the base 11 is deformed so as to follow a direction of distention of the thermally expansive layer 12 using the distention force of the thermally expansive layer 12, and a shape of the thermally expansive layer after the deformation is maintained. In such a manner, a shaped article is formed using the formable resin sheet 10.

The base 11 is a sheet-like member that supports the thermally expansive layer 12, and the thermally expansive layer 12 is provided on one side (first surface) of the base 11. The base 11 is a sheet made of resin. The resin is, for example, a thermoplastic resin. The thermoplastic resin is, for example, (i) polyolefins such as polyethylene (PE) or polypropylene (PP), (ii) polyethylene terephthalate (PET), (iii) polybutylene terephthalate (PBT), (iv) polyester resin, (v) polyamides such as nylon, (vi) vinyl chloride (PVC), (vii) polyimide, or the like. However, the thermoplastic resin is not limited to those compounds. The thickness of the base is 100 μm to 1000 μm. However, the thickness of the base is not limited to such a numerical range.

Also, since the base 11 is required to be deformed by the distention force of the thermally expansive layer 12 or the like, material of the base 11, a thickness of the base 11, and the like are determined which enable the base 11 to be easily deformed by the distention force of the thermally expansive layer 12 In addition, since the shape of the base 11 must be maintained after deformation of the base, the material of the base 11, the thickness of the base 11, and the like are determined which enable maintenance of the shape of the base after the deformation. Also, the base 11 is designed to use a material suitable in accordance with the use for a shaped article 20 after processing, have a thickness suitable in accordance with the use for the shaped article 20 after processing, and the like. For example, depending on the use for the shaped article 20, in addition to maintaining the shape of the base after the deformation of the base, the base is required to have an elastic force that enables the base to return to its original shape after being deformed by pressing. In such a case, the material of the base 11 or the like is determined which enables the base 11 to have the elastic force required after the deformation of the base.

The thermally expansive layer 12 is provided on one surface (upper surface in FIG. 1) of the base 11. The thermally expansive layer 12 is a layer that distends to have a size according to the degree of heating (for example, heating temperature, heating time), and a thermally expandable material (thermally expandable microcapsule, micropowder) is dispersed and arranged in a binder. The thermally expansive layer 12 contains 10% to 70% by weight of the thermally expandable material relative to the binder. However, an amount of the thermally expandable material by weight is not limited to such a numerical range. The thermally expansive layer 12 may be a plurality of layers without being limited to one layer. Any thermoplastic resin such as ethylene-vinyl acetate polymer, acrylic polymer or the like is used as the binder of the thermally expansive layer 12. Also, each of the thermally expandable microcapsules includes propane, butane, and another low boiling point vaporized substance (foaming agent) that are contained in a shell of a thermoplastic resin. The shell is made of, for example, a thermoplastic resin such as polystyrene, polyvinyl chloride, polyvinylidene chloride, polyvinyl acetate, polyacrylic ester, polyacrylonitrile, polybutadiene, or a copolymer thereof. For example, the average particle size of the thermally expandable microcapsules is about 5 to 50 μm. When the microcapsules are heated to a thermal expansion start temperature or more, the shells made of resin are softened, the low boiling point vaporized substances contained therein are vaporized, and the shells expand like a balloon by pressure due to the vaporization. Depending on the properties of the microcapsules used, the microcapsules expand to have particle sizes that are about five times as large as the particle sizes before the expansion of the microcapsules. The particle sizes of the microcapsules vary, and not all microcapsules have the same particle size.

Also, in the present embodiment, as described later, the thicknesses, materials, and the like of the base 11 and the thermally expansive layer 12 are designed such that an amount of deformation of the base 11 is greater than an amount of an increase in a height due to foam formation by the thermally expansive layer 12. Also, the objective of the present embodiment is, particularly, to deform the base 11 into a desired shape. Accordingly, the thermally expansive layer 12 has only to have at least a thickness that enables the base 11 to be deformed into a desired shape. Thus, the thermally expansive layer 12 is preferably formed to have a thickness that is the same as or thinner than the thickness of the base 11. The thickness of the thermally expansive layer 12 is, for example, 5 μm to 200 μm. However, the thickness of the thermally expansive layer 12 is not limited to such a numerical range. Also, for example, if the thermally expansive layer 12 must be formed thickly, for example, for the reason that (i) the base 11 is made of a material that is difficult to deform or (ii) there is need to foam the thermally expansive layer 12 highly depending on a shape of the shaped article, the thermally expansive layer 12 may be formed to be thicker than the base 11.

In addition, it is sufficient that the thermally expansive layer 12 is provided at least on an area of the base 11 that is deformed, and the thermally expansive layer 12 is provided to at least partially cover the base 11.

Method for Manufacturing the Formable Resin Sheet

Also, the formable resin sheet 10 of the present embodiment is manufactured as described below.

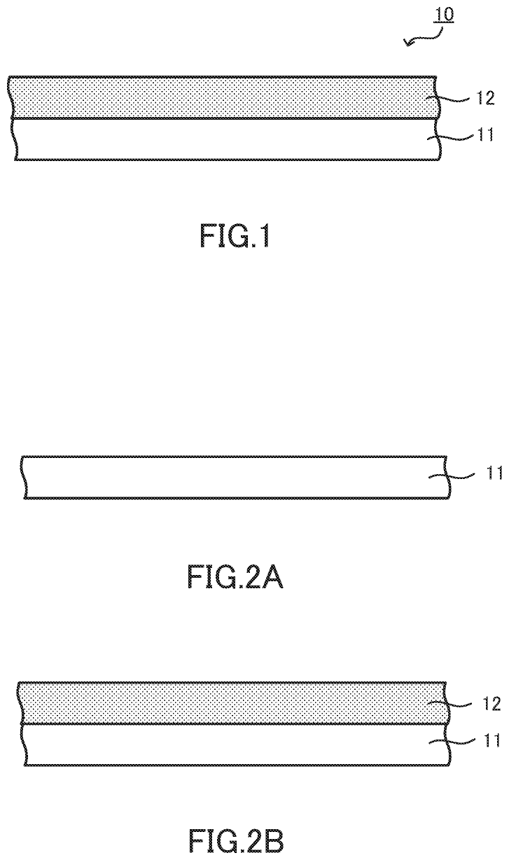

First, as illustrated in FIG. 2A, a sheet made of a sheet-like material, for example, polyethylene terephthalate (PET) is prepared as the base 11. The base 11 may have a roll shape or may be cut in advance.

Next, the binder made of a thermoplastic resin or the like is mixed with the thermally expandable material (thermally expandable microcapsules) to prepare a coating solution for forming the thermally expansive layer 12. Subsequently, the coating solution is applied onto the base 11 using a publically well-known coating device such as a bar coater, a roller coater, a spray coater or the like. The thermally expansive layer 12 may be formed using an apparatus other than the coating apparatus, for example, a printing device. Subsequently, a coated film is dried to form the thermally expansive layer 12 as illustrated in FIG. 2B. In order to obtain a desired thickness of the thermally expansive layer 12, application of and drying of the coating solution may be performed multiple times. Also, in a case in which the roll-shaped base 11 is used, the base 11 is cut if necessary.

As a result, the formable resin sheet 10 is manufactured.

Shaped Article 20

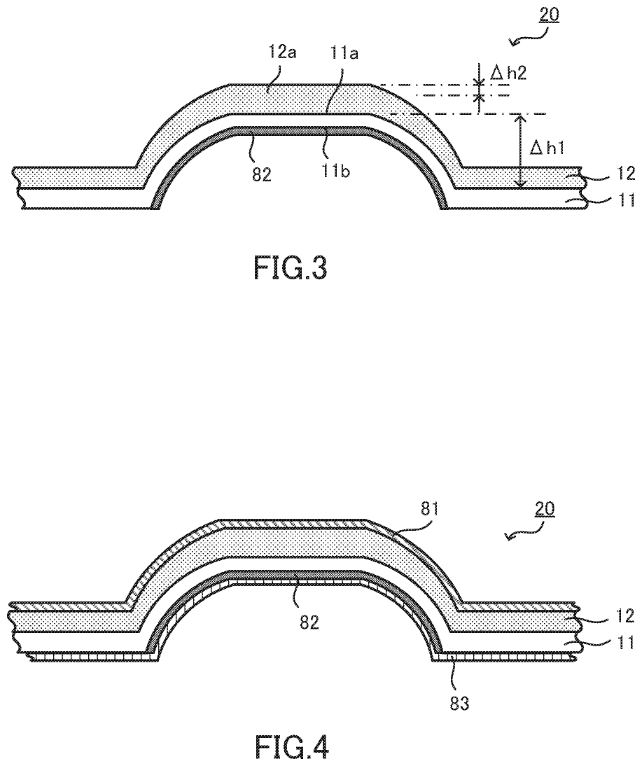

Next, the shaped article 20 is described with reference to FIG. 3.

The shaped article 20 is a sheet obtained by molding the formable resin sheet 10. Specifically, as illustrated in FIG. 3, the base 11 includes (i) a convex portion 11a on its upper surface, and (ii) a concave portion 11b that is formed on its lower surface and has a shape corresponding to the convex portion 11a. The thermally expansive layer 12 includes a convex portion 12a on its upper surface. The convex portion 11a of the base 11 and the convex portion 12a of the thermally expansive layer 12 protrude from the surrounding area. Also, a thermal conversion layer 82 for covering the concave portion 11b of the base 11 to distend the thermally expansive layer 12 is formed.

In the present embodiment, as described later in detail, an electromagnetic wave-heat conversion layer (hereinafter, simply referred to as a thermal conversion layer or conversion layer) that converts electromagnetic waves into heat is formed on the lower surface (back surface) of the formable resin sheet 10, and the electromagnetic wave-heat conversion layer causes the thermal conversion layer 82 to generate heat by emitting an electromagnetic wave. The thermal conversion layer 82 can be also referred to as a heated layer since the thermal conversion layer becomes heated due to the emission of the electromagnetic wave. The heat generated by the thermal conversion layer 82 provided on the back surface of the formable resin sheet 10 is transferred to the base 11. At this time, it is preferable that the base material 11 is softened. In addition, the heat generated by the thermal conversion layer 82 is transferred to the thermally expansive layer 12, thereby causing the thermally expandable material in the thermally expansive layer 12 to foam. As a result, the thermally expansive layer 12 distends. The thermal conversion layer 82 converts the electromagnetic wave into heat more quickly, as compared with other areas where the thermal conversion layer 82 is not provided. Accordingly, only the area in the vicinity of the thermal conversion layer 82 can be selectively heated, and only a specific area of the thermally expansive layer 12 can be selectively distended. Also, the base 11 deforms in the expansion direction of the thermally expansive layer 12 when the thermally expansive layer 12 is foamed and distended, and the base maintains its shape achieved after the deformation of the base.

By the distention of the thermally expansive layer 12, the convex portion 12a illustrated in FIG. 3 is formed on the thermally expansive layer 12. When this convex portion 12a is formed, the expansion force of the thermally expansive layer 12 acts in the direction opposite to the base 11, that is, in the upward direction in FIG. 3. The base 11 is deformed upward in FIG. 3 such that the base is pulled by this expansion force. The convex portion 11a is formed on the upper surface of the base 11 such that the convex portion 11a protrudes from the surrounding area. Also, the concave portion 11b corresponding to the shape of the convex portion 11a formed on the front surface of the base 11 is formed on the back surface of the base 11. The shape of the concave portion 11b is substantially the same as the shape of the convex portion 11a and is a shape obtained by reducing the convex portion 11a by the thickness of the base 11. In the present disclosure, the shapes of the convex portions 12a of the thermally expansive layer 12, the convex portions 11a and the concave portions 11b of the base 11 are expressed as an embossed shape.

In one method of techniques for so-called embossing, uneven shapes corresponding to an upper mold and a lower mold are formed, and a sheet is sandwiched between the upper and lower molds and pressed to form the uneven shapes on surfaces of the sheet. On the other hand, no mold is used in the present embodiment since the base 11 is deformed by the expansion force of the thermally expansive layer 12 pulling the base. However, since the shape of the base after the deformation of the base is similar to a shape formed by embossing, in the present disclosure, shapes like the convex portion 12a of the thermally expansive layer 12 and the convex portion 11a and the concave portion 11b of the base 11 are referred to as an embossed shape.

Also, in order to deform the base 11 particularly using the thermally expansive layer 12, as illustrated in FIG. 3, an amount Δh1 of deformation of the base 11 is greater than a foaming height Δh2 of the heat expansive layer 12 in the shaped article 20 of the present embodiment. The amount Δh1 of deformation of the base is the height of the convex portion 11a that is compared with the surface of an area of the base 11 that is not deformed. The forming height (difference) Δh2 of the thermally expansive layer 12 is obtained by subtracting the height of the thermally expansive layer 12 before distention of the layer 12 from the height of the thermally expansive layer 12 after distention of the layer 12. Also, the difference Δh2 can also be referred to as an increase in the height of the thermally expansive layer 12 caused by distention of the thermally expandable material.

In the present embodiment, it is not essential that the shaped article 20 is colored. However, as illustrated in FIG. 4, a color ink layer 81 may be provided on the front side of the article 20 and a color ink layer 83 may be provided on the back side of the article 20. Both of the color ink layers 81 and 83 may be formed, or only one of the ink layers 81 and 83 may be formed. In particular, since the thermally expansive layer 12 is formed on the front side of the shaped article 20, the color ink layer 81 provided on the thermally expansive layer 12 exhibits a matte texture. On the other hand, since the base 11 made of resin is located on the back side of the shaped article 20, the color ink layer 83 provided on the back side of the substrate 11 exhibits a glossy texture, that is, so-called feeling of gloss. Different textures on the front side and the back side of the shaped article 20 can be achieved by utilizing such a difference between the materials in textures.

Switches and Electronic Device

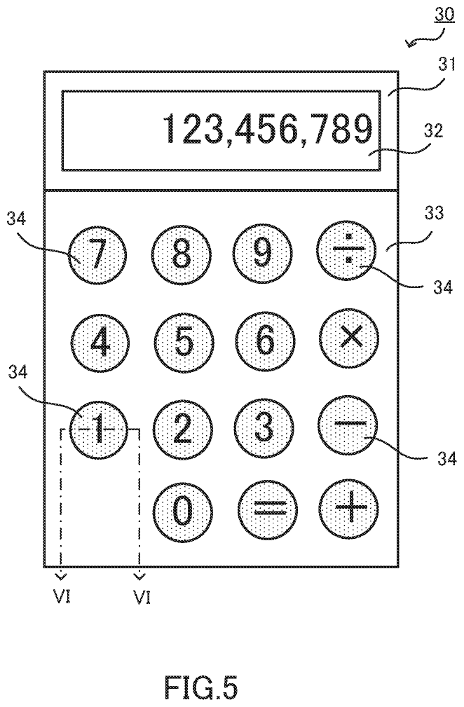

Next, switches 34 using the shaped article 20 of the present embodiment and an electronic device 30 including the switches 34 are described with reference to the drawings. The switches 34 and the electronic device 30 of the present embodiment are examples of a product provided with the shaped article 20. As described later, since the electronic device 30 includes the shaped article 20 as a decorative cover of an inputter 33, the electronic device 30 is also a product including the shaped article 20. FIG. 5 illustrates a calculator as an example of the electronic device 30, and a configuration in which the switches 34 of the present embodiment is used as a key top of the calculator is taken as an example. The electronic device 30 is not limited to calculators and may be a printer, a remote controller, or another electronic device. Also, the function and purpose of the switches 34 of the present embodiment can be freely selected. The present disclosure is not limited to the purpose of inputting numbers, letters and the like as in the present embodiment, and the switches 34 may be a switch for simply turning on and off power or may be used for other purposes.

The electronic device 30 includes a display 31, the inputter 33, and a non-illustrated controller. The display 31 includes a display panel 32 such as a liquid crystal panel, and the display panel 32 displays information such as a number input through the inputter 33 and a calculation result. The inputter 33 includes the switches (key tops) 34 on which operation symbols such as numbers 0 to 9 and four arithmetic operations are described. Also, the non-illustrated controller includes an integrated circuit and the like, performs calculation on the information input through the inputter 33, and displays a result of the calculation on the display unit 31. In the present embodiment, the shaped article 20 is used as a surface sheet (decorative sheet) for decorating the inputter 33.

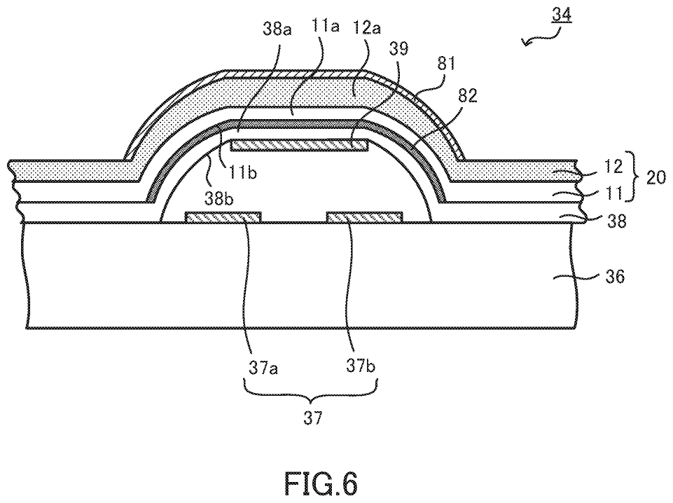

The switches 34 are a so-called membrane switch as illustrated in FIG. 6, and each switch 34 includes (i) a lower contact portion 37 (contact pads 37a and 37b) provided on a circuit board 36, (ii) an upper sheet 38 provided on the circuit board 36, (iii) an upper contact portion 39 provided on the lower surface of the upper sheet 38, and (iv) the shaped article 20. FIG. 6 is a cross-sectional view taken along the line VI-VI illustrated in FIG. 5. Also, the circuit board 36 may be housed in a non-illustrated housing.

The lower contact portion 37 includes the contact pads 37a and 37b. The contact pads 37a and 37b are made of a conductive material and are spaced apart from each other. Also, each of the contact pads 37a and 37b is connected to a non-illustrated wire. When the upper contact portion 39 comes into contact with the contact pads 37a and 37b, the contact pads 37a and 37b are electrically connected to each other, and the press of the switch 34 is detected.

The configuration of the lower contact portion 37 can be freely selected, and the contact pads 37a and 37b may be formed integrally with each other. For example, the lower contact portion 37 may be formed such that a planer portion of the lower contact portion 37 facing the upper contact portion 39 is folded several times. In this case, when the upper contact portion 39 comes into contact with the contact pads 37a and 37b with the upper contact portion 39 between the pads 37a and 37b, the resistivity of the lower contact portion 37 changes, and thus the press of the switch 34 is detected.

The upper sheet 38 is a sheet made of a non-conductive material, for example, a resin such as polyethylene terephthalate (PET). A convex portion 38a and a concave portion 38b having a shape corresponding to the convex portion 38a are formed on an area of the lower surface of the upper sheet 38 that faces the lower contact portion 37, and the lower surface of the upper sheet 38 is a surface facing the circuit board 36. The concave portion 38b forms a dome-like space between the upper sheet 38 and the circuit board 36. The concave portion 38b faces the lower contact portion 37, and the upper contact portion 39 is provided at the center of the concave portion 38b. The convex portion 38a of the upper sheet 38 is dented by pressing the convex portion 38a and returns to its original shape by releasing the convex portion 38a from the pressing.

The upper contact portion 39 includes a conductive material and is provided at a position at which the upper contact portion 39 faces the lower contact portion 37. Also, the upper contact portion 39 has, for example, a circular planar shape. Examples of the conductive material include copper and silver. The conductive material may also include other known materials. The upper contact portion 39 comes into contact with the lower contact portion 37 to electrically connect the contact pads 37a and 37b of the lower contact portion 37.

The shaped article 20 is provided on the outmost surface of the switch 34 such that the shaped article covers the upper sheet 38. The base 11 of the shaped article 20 includes the convex portion 11a and further includes the concave portion 11b formed in a shape corresponding to the convex portion 11a. The concave portion 11b is formed in a shape and a size that enable the concave portion 11b to cover the convex portion 38a provided on the upper sheet 38. The shaped article 20 further includes the color ink layer 81 on the thermally expansive layer 12. A color of the switch, a numeral to be displayed, and the like can be expressed by the color ink layer 81. The color ink layer 81 may be provided not only on the convex portion 12a but also on the periphery of the convex portion 12a. Furthermore, an additional protective film or the like may be provided on the shaped article 20.

In the switch 34, the shaped article 20 is pressed downward from the upper side of FIG. 6. Specifically, the convex portion 11a of the base 11, the convex portion 38a of the upper sheet 38 and the like are pressed downward. The shaped article 20 and the upper sheet 38 deform so as to be concaved due to this force, so that the upper contact portion 39 comes into contact with the lower contact portion 37. As a result, since the contact pads 37a and 37b are electrically connected, the press of the switch 34 is detected. Since the shaped article is used for a calculator in this embodiment, input of a number or an operation symbol is detected. Also, when the shaped article 20 is released from the force for pressing the shaped article or the like, the shaped article 20 and the upper sheet 38 return to their original shapes.

Method of Manufacturing Shaped Article

Next, a flow of a shaped article manufacturing method of manufacturing a shaped article by molding the formable resin sheet 10 (resin molding processing) is described. Although a case of the use of the formable resin sheet 10 wound into a roll (roll type) is described as an example in the shaped article manufacturing method described below, a sheet-fed type may be employed.

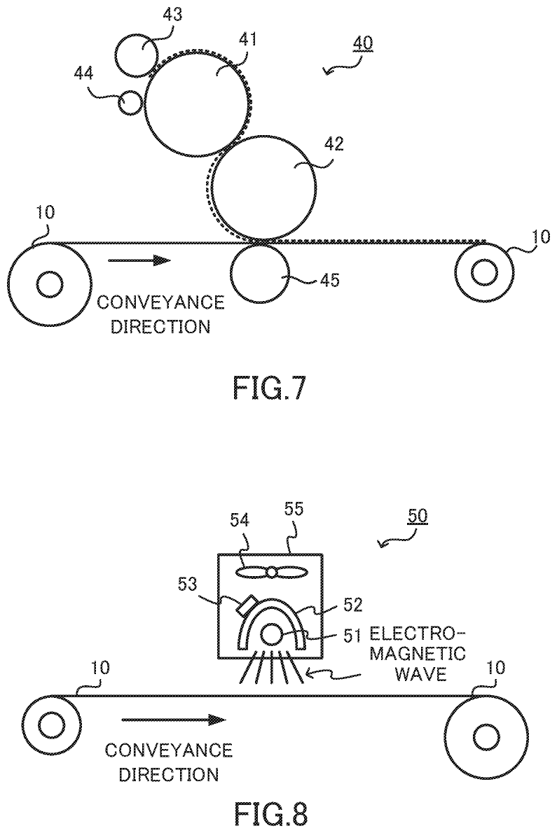

First, a printing device 40 and an expansion device 50 are described which are used in the method of manufacturing the shaped article 20 of the present embodiment. For example, an offset printing device is used as the printing device 40 for printing a color image and the thermal conversion layer. As illustrated in FIG. 7, the printing device 40 includes a plate cylinder 41, a blanket 42, an ink roller 43, a water roller 44, and an impression cylinder 45.

The plate cylinder 41 includes a press plate on its surface and the press plate includes an image area and a non-image area. The image area is lipophilic (water repellent), and the non-image area is hydrophilic. The image area and the non-image area are formed, for example, using photolithography. Specifically, an lipophilic photosensitive layer is provided on a hydrophilic support, and the photosensitive layer is exposed through a mask (negative film) in which only the image area is exposed. Subsequently, by removing the photosensitive layer in the non-image area, only the lipophilic photosensitive layer remains on the image area. The method of producing the press plate is freely selected, and the press plate may be produced by printing data to be printed directly on the press plate using a laser or the like without using such a film.

A dampening solution is supplied to the plate cylinder 41 by the water roller 44. The dampening solution exists only on the non-image area (hydrophilic) of the press plate on the plate cylinder. Also, ink is supplied to the plate cylinder 41 by the ink roller 43. The ink does not exists on the non-image area on which the water exists, and the ink adheres only to the image area (lipophilic) of the press plate.

The blanket 42 is made of, for example, a rubber cylinder. The ink adhering to the plate cylinder 41 is transferred to the blanket 42. Also, the impression cylinder 45 is disposed at a position at which the impression cylinder 45 faces the blanket 42. Furthermore, the ink on the blanket 42 is transferred onto the formable resin sheet 10 by the contact between the blanket 42 and the surface of the formable resin sheet 10.

When printing a color image (color ink layer), the device illustrated in FIG. 7 is used for each of four colors of cyan C, magenta M, yellow Y and black K. Also, publically known inks are used as the inks of cyan C, magenta M, yellow Y and black K. In addition, the printing devices 40 for printing images of the respective colors may be installed individually or continuously. When the printing devices 40 are continuously installed, the formable resin sheet 10 taken out of a roll is sequentially conveyed to the printing devices 40 for the respective colors of CMYK, and the CMYK images are printed in order. At a stage where the formable resin sheet 10 is wound up, a color image is printed on the front surface of the formable resin sheet 10. Also, an order in which the colors are printed can be optionally changed.

In the present embodiment, the thermal conversion layer 82 is made to generate heat by emitting an electromagnetic wave to the thermal conversion layer. As a result, if carbon is contained in the black ink (K) used for printing a color image, the carbon may absorb the electromagnetic wave and generate heat. Accordingly, it is preferable that the black ink (K) does not contain carbon.

Also, in a case in which the thermal conversion layer 82 is printed, the ink supplied to the ink roller in the printing device 40 illustrated in FIG. 7 is an ink containing an electromagnetic wave-heat conversion material (hereinafter referred to as a foaming ink). The electromagnetic wave-heat conversion material (thermal conversion material) is a material capable of converting an electromagnetic wave into heat. One example of the thermal conversion material is carbon black (graphite) which is a carbon molecule. In this case, by emitting the electromagnetic wave, the graphite absorbs the electromagnetic wave and thermally vibrates to generate heat. The thermal conversion material is not limited to graphite, and, for example, an inorganic material such as an infrared absorbing material may be also used as such a material. Specifically, such an infrared absorbing material is preferably a metal hexaboride compound or a tungsten oxide compound. In particular, such an infrared absorbing material is preferably lanthanum hexaboride (LaB₆) or cesium tungsten oxide since the lanthanum hexaboride and the cesium tungsten oxide have high absorptivity (low transmittance) in the near infrared region and high transmittance in the visible light region. The above-described inorganic infrared absorbing materials may be used alone or in combination of two or more different materials.

Also, the color of the foaming ink is freely selectable and may be, for example, black or white. The foaming ink may be colored in accordance with the color of the base 11. Also, the use of lanthanum hexaboride (LaB₆) or cesium tungsten oxide as the thermal conversion material is particularly preferable since the color of the foaming ink can be suppressed by the use of these compounds. In this case, the foaming ink may be transparent (a color that is difficult to see or can not be seen).

Next, the expansion device 50 for distending the thermally expansive layer 12 is illustrated in FIG. 8. The expansion device 50 includes an emitter 51, a reflector plate 52, a temperature sensor 53, a cooling unit 54, and a housing 55. The emitter 51, the reflector plate 52, the temperature sensor 53 and the cooling unit 54 are housed in the housing 55. The formable resin sheet 10 is conveyed under the expansion device 50.

The emitter 51 includes a lamp heater, for example, such as a halogen lamp, and emits, to the formable resin sheet 10, an electromagnetic wave (light) in the near infrared region (wavelength: 750 to 1400 nm), in the visible light region (wavelength: 380 to 750 nm), or in the mid-infrared region (wavelength: 1400 to 4000 nm). When an electromagnetic wave is emitted to the formable resin sheet 10 on which the thermal conversion layer 82 of the foaming ink containing the thermal conversion material is printed, the electromagnetic wave is converted into heat more efficiently in a portion on which the thermal conversion layer 82 is printed than in a portion on which the thermal conversion layer 82 is not printed. Accordingly, the portion of the formable resin sheet 10 on which the thermal conversion layer 82 is printed is mainly heated, and the thermally expandable material distends when the temperature of the thermally expandable material reaches a temperature causing the thermally expandable material to start expansion. The emitter 51 is not limited to the halogen lamp, and the emitter 51 may have any other structure capable of emitting electromagnetic waves. Also, a wavelength range of the electromagnetic waves is not limited to the above-described ranges.

The reflector plate 52 is (i) an irradiated body that receives the electromagnetic wave emitted from the emitter 51 and (ii) is a mechanism that reflects the electromagnetic wave emitted from the lamp heater toward the formable resin sheet 10. The reflector plate 52 is disposed to cover the upper side of the emitter 51 and reflects downward the electromagnetic wave emitted upward from the emitter (lamp heater) 51. The reflector plate 52 makes it possible to efficiently emit to the formable resin sheet 10 the electromagnetic wave emitted from the lamp heater.

The temperature sensor 53 is a thermocouple, a thermistor or the like and functions as measurement means that measures a temperature of the reflector plate 52. The temperature sensor 53 measures the temperature of the reflector plate 52 during emission of the electromagnetic wave by the emitter 51. Since the reflector plate 52 receives the electromagnetic wave emitted from the emitter 51, the temperature of the reflector plate 52 changes in accordance with the intensity of the electromagnetic wave emitted by the emitter 51, that is, a magnitude of the energy of the electromagnetic wave. Accordingly, the temperature of the reflecting plate 52 can also be used as an index of the intensity of the electromagnetic wave emitted by the emitter 51.

The cooling unit 54 is provided on the upper side of the reflector plate 52 and functions as cooling means that cools the inside of the expansion device 50. The cooling unit 54 includes at least one air supply fan and cools the emitter 51 by supplying air from the outside of the expansion device 50 to the emitter 51.

In the expansion device 50, the formable resin sheet 10 is pulled out from the roll and receives an electromagnetic wave emitted by the emitter 51 while being transported by a non-illustrated transport roller. As a result, the thermal conversion layer 82 provided on the formable resin sheet 10 generates heat. This heat is transferred to the base 11 and the thermally expansive layer 12. At least a portion of the thermally expansive layer 12 distends. Also, the base 11 may be softened by this heat. The base 11 is pulled by force caused by the distention of the thermally expansive layer 12, and as a result, the base 11 is deformed. After the distention of the thermally expansive layer 12, the formable resin sheet 10 is wound up. Depending on the amount of deformation of the base 11, the formable resin sheet 10 may be cut without being wound up.

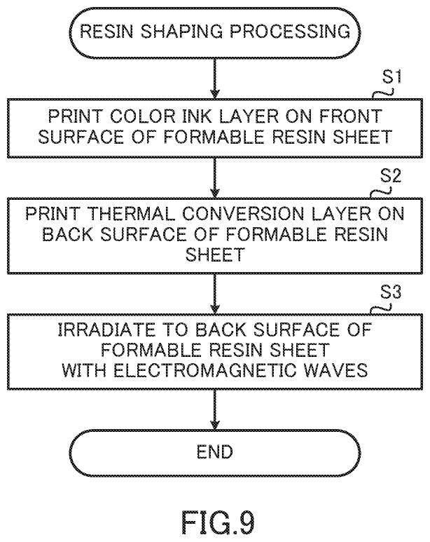

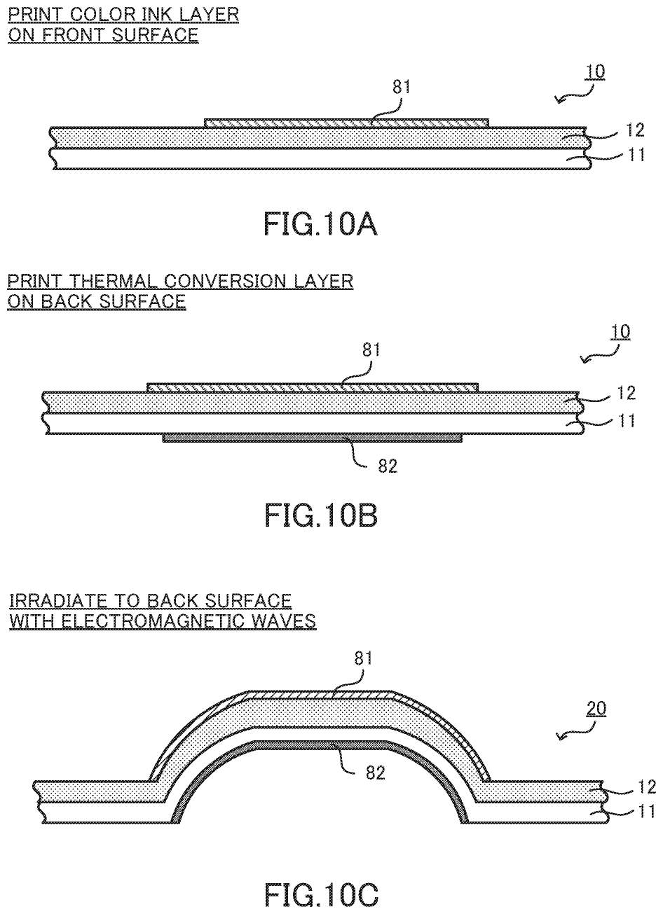

Next, with reference to a flowchart illustrated in FIG. 9 and the cross-sectional views of the formable resin sheet 10 illustrated in FIGS. 10A to 10C, the flow of processing for molding the formable resin sheet 10 and forming a shaped object on the front surface of the sheet is described.

First, the formable resin sheet 10 is prepared. Also, (i) color image data for forming the color ink layer 81 and (ii) foaming data indicating a portion to be foamed and distended on the front surface of the formable resin sheet 10 (data for forming the thermal conversion layer 82) are determined in advance. The formable resin sheet 10 is conveyed to the printing device 40 illustrated in FIG. 7 with the front surface of the formable resin sheet facing upward, and a color image (color ink layer 81) is printed on the front surface of the formable resin sheet 10 using the printing device 40 (step S1). Specifically, the respective printing devices 40 for cyan C, magenta M, yellow Y and black K print an image colored in cyan C, magenta M, yellow Y and black K on the front surface of the formable resin sheet 10 in accordance with the designated color image data. As a result, as illustrated in FIG. 10A, the color ink layer 81 is formed on the front surface of the formable resin sheet 10.

Second, the thermal conversion layer 82 is printed on the back surface of the formable resin sheet 10 using the printing device 40 (step S2). The thermal conversion layer 82 is a layer formed of the ink containing the electromagnetic wave-heat conversion material, for example, the foaming ink containing carbon black. The printing device 40 prints the foaming ink containing the thermal conversion material on the back surface of the formable resin sheet 10 in accordance with the designated foaming data. As a result, as illustrated in FIG. 10B, the thermal conversion layer 82 is formed on the back surface of the formable resin sheet 10. If the thermal conversion layer 82 is printed thickly, the amount of heat generation is increased, so that the thermally expansive layer 12 distends high. Accordingly, a high amount of deformation of the base 11 can be obtained. The deformation height can also be controlled by controlling the density of the thermal conversion layer 82 using this.

Third, the formable resin sheet 10 on which the thermal conversion layer 82 is printed is conveyed to the expansion device 50 such that the back surface of the formable resin sheet faces upward. In the expansion device 50, the emitter 51 emits an electromagnetic wave to the conveyed formable resin sheet 10 (Step S3). Specifically, in the expansion device 50, the emitter 51 emits the electromagnetic wave to the back surface of the formable resin sheet 10. The thermal conversion material contained in the thermal conversion layer 82 printed on the back surface of the formable resin sheet 10 absorbs the emitted electromagnetic wave to generate heat. As a result, the thermal conversion layer 82 generates heat, the heat generated by the thermal conversion layer 82 is transferred to the thermally expansive layer 12, and the thermally expandable material foams and expands. It is preferable that the heat generated by the thermal conversion layer 82 softens the base 11. As a result of the distention of the thermally expansive layer 12, as illustrated in FIG. 10C, a portion of the thermally expansive layer 12 of the formable resin sheet 10 on which the thermal conversion layer 82 is printed distends and swells. The base 11 is pulled by the force caused by the distention of the thermally expansive layer 12 and thus is deformed.

A shaped object is formed on the surface of the formable resin sheet 10 by the above-described procedure, and thus the shaped article 20 is manufactured.

As described above, in the formable resin sheet, the shaped article, and the method for producing the shaped article according to the present embodiment, the thermal conversion layer 82 is formed by printing, and the formable resin sheet 10 can be easily deformed into a desired shape by emitting the electromagnetic wave to the thermal conversion layer 82. In particular, by the use of the printing process and the emission of the electromagnetic wave, a mold for molding or the like becomes unnecessary, and it becomes possible to reduce the time and cost required for molding the formable resin sheet 10.

Also, particularly, in a case of the use as a switch as in the above-described embodiment, the thermally expansive layer 12 located on the base 11 deformed into a dome shape is distended in order to deform the base 11. Accordingly, areas of the thermally expansive layer 12 functioning as a switch have a more increased elasticity as compared with the other areas of the thermally expansive layer, and an effect of providing cushioning can also be added.

Also, in the present embodiment, by the use of the control of the density of the thermal conversion layer (foaming data) 82, the control of electromagnetic waves, and the like, a position at which the thermally expansive layer 12 is made to swell, the height of the thermally expansive layer 12 made to swell, and the like can be controlled optionally, thereby making it possible to easily mold the formable resin sheet 10 to form a shaped object. Furthermore, printing processes of a color image can be combined, thereby making it possible to form the shaped object well.

In this case, the control of the electromagnetic wave means control of an amount of energy received per unit area by the formable resin sheet 10 in order to distend the formable resin sheet 10 to have a desired height when the formable resin sheet 10 is distended by emitting the electromagnetic wave to the formable resin sheet 10 in the expansion device 50. Specifically, the amount of energy that the formable resin sheet 10 receives per unit area varies in accordance with parameters such as a radiant intensity of the emitter, a moving speed, emission time, an emission distance, temperature, humidity, cooling and the like. The control of the electromagnetic wave is performed by controlling at least one of such parameters.

In the above-described embodiment, the offset printing device with water is described as an example of the printing device 40. However, the present disclosure is not limited to such a device. The printing device 40 may be a waterless offset printing device. Also, the present disclosure is not limited to the use of the offset printing device, and any printing devices including a gravure printing device, a silk screen printing device, a flexographic printing device, and an inkjet printing device are also available. Also, publically-known inks including water-based ink, solvent-based ink, and ultraviolet curing ink may be used as the ink used in each printing device. Also, the configuration of the expansion device 50 is not limited to the configuration illustrated in FIG. 8.

### MODIFIED EXAMPLE

Although the configuration that utilizes the shaped article 20 as a decorative cover of the switch 34 is described as an example in Embodiment 1 described above, the present disclosure is not limited to this configuration. For example, the upper sheet 38 may be omitted.

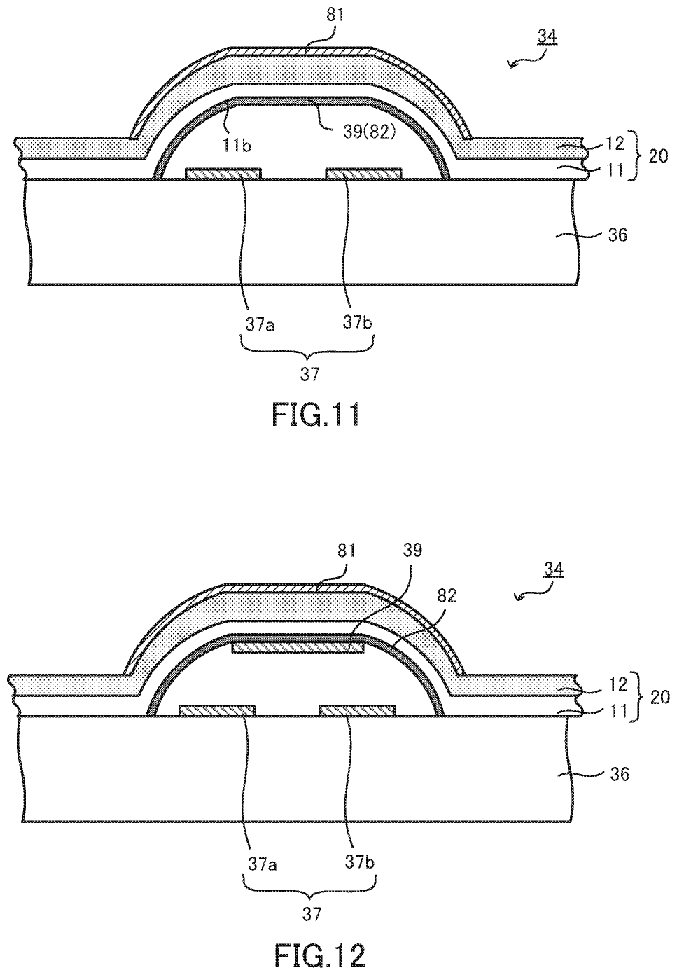

Specifically, as illustrated in FIG. 11, the thermal conversion layer 82 provided on the back surface of the shaped article 20 can be made to function as the upper contact portion 39. In this case, as illustrated in FIG. 11, the switch 34 includes the lower contact portion 37 provided on the circuit board 36, the upper contact portion 39, and the shaped article 20. In the present modified example, the upper contact portion 39 provided in the concave portion 11b of the base 11 of the shaped article 20 is the thermal conversion layer 82 used for distending the thermally expansive layer 12. In other words, in the present modified example, the thermal conversion layer 82 also has the functions of the upper contact portion 39.

Such a thermal conversion layer 82 is preferably formed using the foaming ink containing the electromagnetic wave-heat conversion material having conductivity. One example of such a material is carbon black (graphite). In addition, in order to change the conductivity of the thermal conversion layer 82, a conductive material such as a silver paste can be further added to the foaming ink. Also, when the electromagnetic wave-heat conversion material has low conductivity or does not have conductivity, the thermal conversion layer 82 as in the present modified example may be formed by adding a conductive material to the foaming ink.

Also, as illustrated in FIG. 12, the upper contact portion 39 is provided directly on the thermal conversion layer 82 provided on the back surface of the shaped article 20, thereby making it possible to omit the upper sheet 38. In this case, the switch 34 includes the lower contact portion 37 provided on the circuit board 36, the upper contact portion 39, and the shaped article 20. In the present modified example, the upper contact portion 39 is disposed on the thermal conversion layer 82 formed on the back surface of the base 11 of the shaped article 20. The upper contact portion 39 may be formed by attaching a conductive material previously formed into a sticker shape or may be formed by printing a conductive paste.

### Embodiment 2

A sticker 60 according to the Embodiment 2 is described below with reference to the drawings. In the present embodiment, the case where the object 20 is used as the sticker 60 is described as an example The sticker 60 of the present embodiment is an example of a product provided with the shaped article 20. Components that are common to Embodiments 1 and 2 are assigned the same reference signs, and detailed descriptions thereof are omitted.

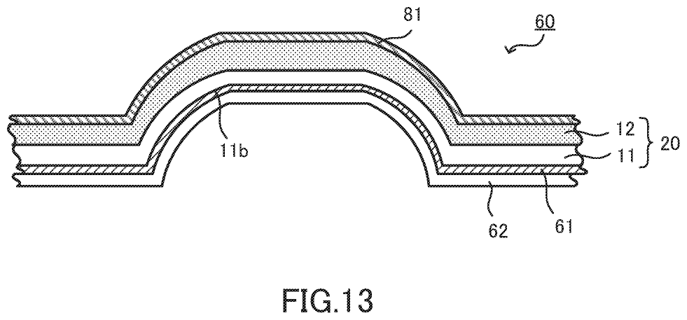

The sticker 60 includes the shaped article 20, an adhesive layer 61, and a peeling sheet 62, as illustrated in FIG. 13. The shaped article 20 is produced from the formable resin sheet 10 via the method described in Embodiment 1. The shaped article 20 includes the thermally expansive layer 12 located on the base 11, and the color ink layer 81 is formed on the upper surface of the thermally expansive layer 12. The thermal conversion layer 82 is omitted in FIG. 13.

The adhesive layer 61 is provided on the back surface of the base 11. The adhesive layer 61 is a layer for adhering the shaped article 20 to an object. The adhesive strength of the adhesive layer 61 is optionally determined in accordance with use of the sticker 60. For example, the caver 60 may have such adhesive strength that the sticker 60 is not easily peeled from the object or such adhesive strength that the sticker 60 is easily peeled after being attached to the object. Also, the material contained in the adhesive layer 61 can be optionally determined in accordance with use of the sticker 60. For example, the adhesive layer 61 contains a publically-known adhesive such as a resin-based adhesive containing a thermosetting resin or a thermoplastic resin, an elastomer-based adhesive, or the like. Also, the adhesive layer 61 may contain, instead of such an adhesive, a publically-known adhesive such as a rubber-based adhesive, an acrylic-based adhesive, a silicone-based adhesive, or a urethane-based adhesive.

The peeling sheet 62 is provided to sticker the adhesive layer 61. A resin film (sheet), paper or the like can be used as the peeling sheet 62. The peeling sheet 62 prevents foreign matter from adhering to the adhesive layer 61. Also, the adhesive layer 61 of the sticker 60 can be exposed by peeling off the peeling sheet 62, and thus the sticker 60 can be attached to an object. The peeling sheet 62 may be omitted depending on use of the sticker 60, an object to which the sticker is to be attached, material of the adhesive layer 61, and the like.

The adhesive layer 61 and the peeling sheet 62 may be provided before molding the formable resin sheet 10. In other words, in the state in which the formable resin sheet 10 is not yet subjected to a molding process, the adhesive layer 61 and the peeling sheet 62 are provided on the back surface of the base 11, and then the formable resin sheet 10 including the adhesive layer 61 and the peeling sheet 62 is formed by the method of manufacturing a shaped article described in Embodiment 1, thereby making it possible to produce the sticker 60. In this case, as illustrated in FIG. 13, the adhesive layer 61 is also formed on the concave portion 11b of the base 11. Depending on a shape into which the sheet 10 is formed, the peeling sheet 62 may be partially peeled off under the concave portion 11b.

Also, the adhesive layer 61 and the peeling sheet 62 may be provided after molding of the formable resin sheet. In this case, after the formable resin sheet 10 is formed by the shaped-article producing method according to Embodiment 1, the adhesive layer 61 and the peeling sheet 62 are formed. In this case, the adhesive layer 61 may be provided on the whole of the lower surface of the base 11 including the concave portion 11b as illustrated in the drawing. Alternatively, unlike the illustrated example, the adhesive layer 61 may be provided to cover an area other than one portion of the concave portion 11b or may be provided only on an area other than the concave portion 11b of the base 11. Similarly, the peeling sheet 62 may be also provided to cover the whole of the adhesive layer 61 as illustrated in the drawing. Also, unlike the illustrated example, the peeling sheet 62 may cover the adhesive layer 61 and be provided away from the concave portion 11b of the base 11.

As described above, the thermal conversion layer is formed on the formable resin sheet 10 by printing, and the electromagnetic wave is emitted to the thermal conversion layer, thereby making it possible to easily deform the base into a desired shape to produce the shaped article 20. Accordingly, the sticker 60 as in this embodiment can also be easily produced.

### Embodiment 3

A lighting device 70 according to Embodiment 3 is described with reference to the drawings. The present embodiment is characterized in that the shaped article 20 is used as a lampshade 71 that is a component of the lighting device 70. The lighting device 70 and the lampshade 71 of the present embodiment are examples of a product provided with the shaped article 20. In Embodiment 3, a stand-type lighting device 70 is taken as an example.

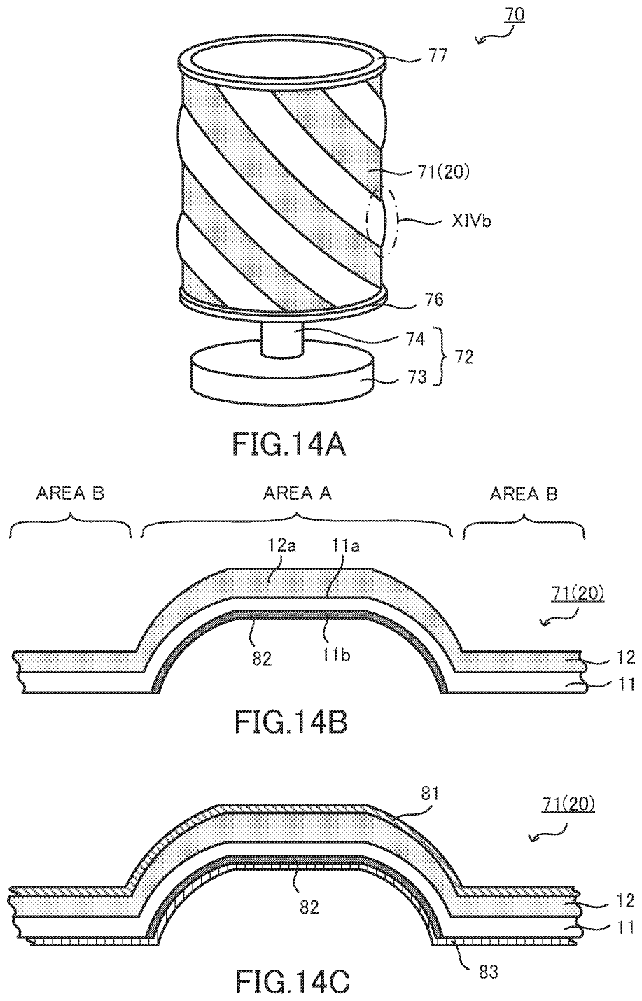

As illustrated in FIG. 14A, the lighting device 70 includes the lampshade 71 and a lamp stand 72. The lamp stand 72 includes a disk-like pedestal 73, a support rod 74 provided at the center of the pedestal 73, and a non-illustrated light source provided at a tip of the support rod. The light source is a light bulb such as a light emitting diode (LED) light bulb. The light source may be any light source, for example, a fluorescent lamp

As shown in FIG. 14A, the lampshade 71 has a cylindrical shape and is displaced at the top of the lamp stand 72 such that the lampshade surrounds the non-illustrated light source. The lampshade 71 is made of the shaped article 20, and frames 76 and 77 are provided at the upper edge and the lower edge of the shaped article 20. As illustrated in FIG. 14A, the shaped article 20 is formed to have a stripe pattern by distending the thermally expansive layer 12.

Also, as illustrated in FIG. 14B, the shaped article 20 has (i) an area A where the base 11 is deformed by the protrusion of the thermally expansive layer 12 and (ii) an area B where the thermally expansive layer 12 has no protrusion and thus the base 11 is not deformed. FIG. 14B is a cross-sectional view of a region enclosed by an alternate long and short dash line in FIG. 14A. In this case, in the area A, the base 11 is deformed by the protrusion of the thermally expansive layer 12. A shaped object can be formed on the shaped article 20 by utilizing the protrusion of the thermally expansive layer 12 and the deformation of the base 11. The areas A and B may or may not be different from each other in light transmittance

Also, since the base 11 is extended in accordance with a deformation of the base, a thickness of the base 11 in the area A is thinner than a thickness of the area B that is not deformed. In particular, in a case in which such a difference in thickness occurs, it is preferable to design the material, thickness, and the like of the base 11 such that the light transmittance of the area A is different from that of the area B. Also, such a difference between the areas A and B in translucency can be made, in particular, by changing the thickness of the thermally expansive layer 12 or the like to form the thermally expansive layer 12 as a transparent layer (having an invisible color) or a light white layer, which is more preferable. Specifically, the area A in which the base 11 is deformed is configured to have higher light transmittance than the area B in which the base 11 is not deformed. As a result, the light source can cause shades of the shaped object formed on the shaped article 20 to stand out on the surface of the lampshade 71.

In the present embodiment, it is not essential that the shaped article 20 is colored. However, as illustrated in FIG. 14C, the color ink layers 81 and 83 may be formed on the front and back surfaces of the shaped article 20. Only one of the color ink layers 81 and 83 may be formed. As described above, in particular, the color ink layer 81 provided on the thermally expansive layer 12 exhibits a matte texture. On the other hand, the color ink layer 83 provided on the back surface of the base 11 exhibits a glossy texture, that is, so-called feeling of gloss. The use of such a difference between materials in texture also makes it possible to express different textures on the front surface and the back surface of the shaped article 20. In particular, in a case of the lampshade as illustrated in FIG. 14A, both the front surface and the back surface of the object 20 can be visually recognized Thus, in particular, different textures on the front and back surfaces can be visually recognized, thereby making it possible to extend a range of expression made by the shaped article 20.

The lampshade 71 is not limited to the case of being used for the free standing stand-type lighting device 70 as illustrated in the drawings, and the lampshade 71 can be used for various lighting devices such as a pendant-type lighting device and a ceiling light. Also, a shape formed on the shaped article 20 is not limited to the illustrated example Depending on the shape formed on the shaped article 20, the shaped article 20 may have an area that is deformed to be higher than the area A and/or an area that is deformed to have a height lower than the height of the area A and higher than the height of the area B. Also, the number of such areas is optional.

Furthermore, as long as the lighting device 70 includes the light source and the shaped article 20, the purpose of the use of the lighting device is not limited. For example, it is not necessary that a main purpose of the use of the lighting device 70 is to illuminate surroundings, and the main purpose of the use of the lighting device 70 may be merely to make shades stand out or may be a purpose for viewing appearing shades.

In the present embodiment, the shaped article 20 is used as the lampshade 71. As described above, the thermal conversion layer 82 is formed on the formable resin sheet 10 by printing and an electromagnetic wave is emitted to the thermal conversion layer, thereby making it possible to easily deform the base into a desired shape to produce the shaped article 20. Thus, the lampshade 71 as in this embodiment can be also easily produced.

Also, particularly, a difference in light transmittance between the area in which the base 11 is deformed and the area in which the base 11 is not deformed is made, thereby making it possible to add an effect of making shades stand out.

### Embodiment 4

A shaped article 22 according to Embodiment 4 is described below with reference to the drawings. The shaped article 22 according to Embodiment 4 is different from the above-described shaped article 20 according to Embodiment 1 in that a front-side conversion layer 84 is formed on the front surface of the sheet and a portion of the thermally expansive layer 12 is further distended in Embodiment 4. Components that are common to Embodiments 1 and 4 are assigned the same reference signs, and detailed descriptions thereof are omitted. Also, a switch of the present embodiment is also an example of a product like Embodiment 1.

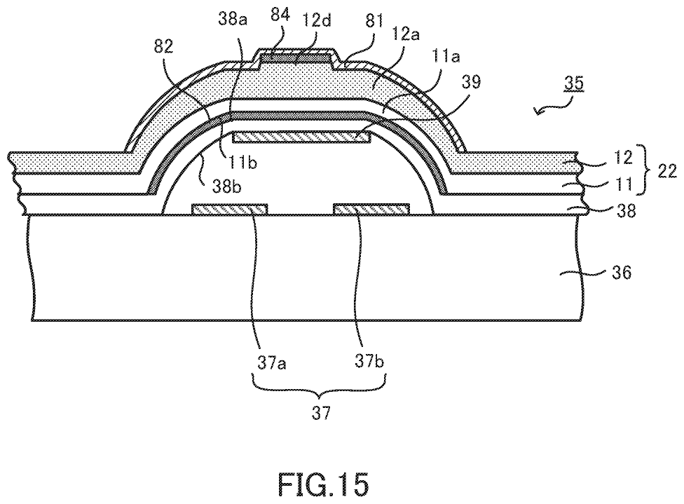

A cross-sectional view of a switch 35 is illustrated in FIG. 15. The switch 35 includes (i) the lower contact portion 37 provided on the circuit board 36, (ii) the upper sheet 38, (iii) the upper contact portion 39 provided on the lower surface of the upper sheet 38, and (iv) the shaped article 22.

The shaped article 22 is provided on the outmost surface of the switch 35 such that the shaped article 22 covers the upper sheet 38. The base 11 of the shaped article 22 includes the convex portion 11a and further includes the concave portion 11b formed in a shape corresponding to the convex portion 11a. The concave portion 11b is formed in a shape and a size that enable the concave portion 11b to cover the convex portion 38a provided on the upper sheet 38. Also, particularly in the present embodiment, a portion of the convex portion 12a of the thermally expansive layer 12 further includes a convex portion 12d. As described later, the front-side conversion layer 84 is formed on the upper surface of the thermally expansive layer 12 and an electromagnetic wave is emitted to the upper surface of the thermally expansive layer 12, thereby causing the convex portion 12d to distend a portion of the thermally expansive layer 12. The shape of the convex portion 12d may be a mark for identification of the switch 35, for example, the numbers or four arithmetic operations illustrated in FIG. 5. Also, the convex portion 12d may be Braille or the like. Also, the shaped article 22 includes the color ink layer 81 formed on the thermally expansive layer 12. The color ink layer 81 can express the color of the switch, the numbers to be displayed, and the like. The color ink layer 81 may be provided not only on the convex portion 12a but also around the convex portion 12a. Furthermore, an additional protective film or the like may be provided on the shaped article 22.

In the switch 35, as in the first embodiment, the shaped article 22 is pressed downward from the upper side of FIG. 15. The shaped article 22 and the upper sheet 38 receive this pressing force and deform so as to dent, and the upper contact portion 39 comes into contact with the lower contact portion 37. Also, when the shaped article 22 is released from the pressing force, the shaped article 22 and the upper sheet 38 return to their original shapes. In particular, since the shaped article according to the present embodiment includes the convex portion 11d, the tactile sensation of the switch 35 can be changed.

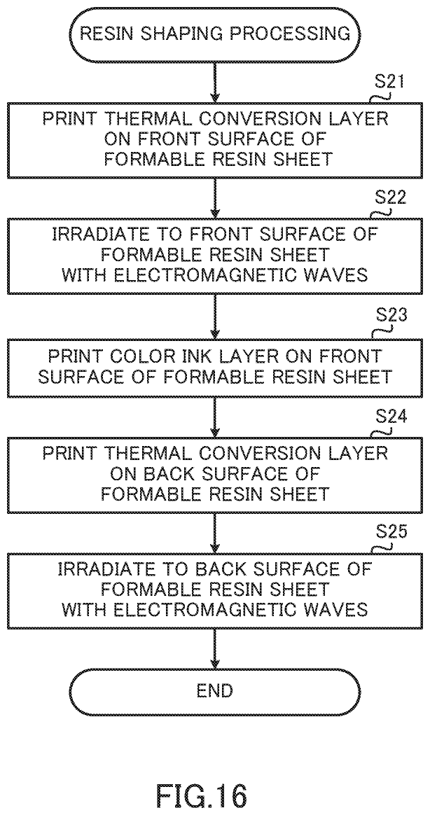

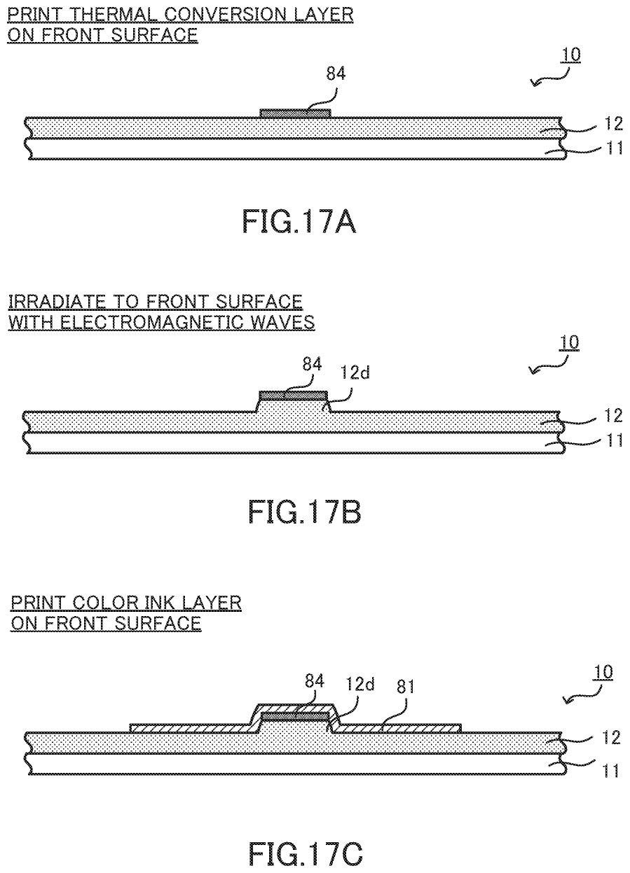

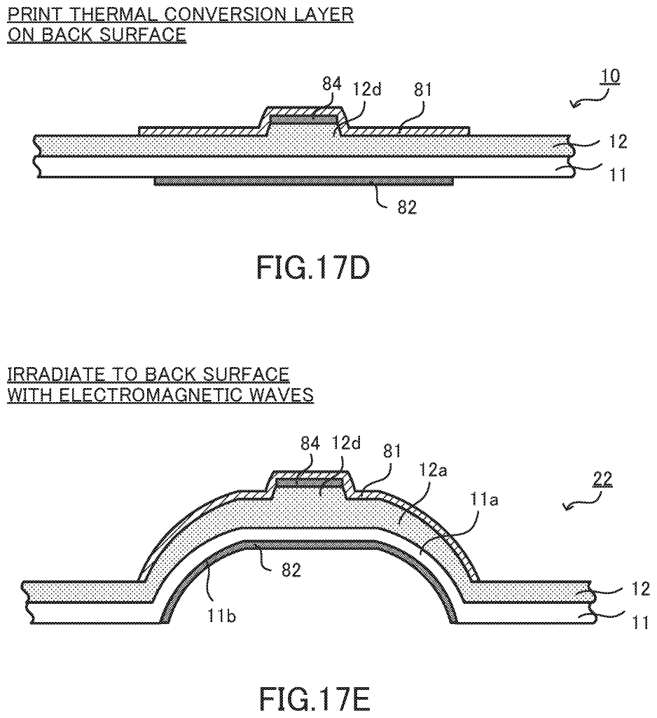

Next, a flow of the method of manufacturing the shaped article by forming a shaped object by molding the formable resin sheet 10 (resin molding processing) is described with reference to a flowchart illustrated in FIG. 16 and cross-sectional views of the formable resin sheet 10 illustrated in FIGS. 17A to 17E.

First, the formable resin sheet 10 is prepared. Color image data for forming the color ink layer 81, front-side foaming data (corresponding to the front-side conversion layer 84) indicating a portion to be foamed and distended on the front surface of the formable resin sheet 10, and foaming data (corresponding to the thermal conversion layer 82) indicating a portion to be foamed and distended on the back surface of the formable resin sheet 10 are determined in advance. Next, the front-side conversion layer 84 is printed on the front surface of the formable resin sheet 10 using the printing device 40 (step S21). The front-side conversion layer 84 is a layer formed of an ink containing an electromagnetic wave-heat conversion material, for example, a foaming ink containing carbon black. The printing device 40 performs printing on the front surface of the formable resin sheet 10 using the foaming ink in accordance with the designated front-side foaming data As a result, as illustrated in FIG. 17A, the front-side conversion layer 84 is formed on the front surface of the formable resin sheet 10.

Second, the formable resin sheet 10 on which the front-side conversion layer 84 is printed is conveyed to the expansion device 50 such that the front surface of the sheet 10 faces upward. In the expansion device 50, the emitter 51 emits an electromagnetic wave to the conveyed formable resin sheet 10 (step S22). Specifically, in the expansion device 50, the emitter 51 emits the electromagnetic wave to the front surface of the formable resin sheet 10. The thermal conversion material contained in the front-side conversion layer 84 printed on the front surface of the formable resin sheet 10 absorbs the emitted electromagnetic waves and generates heat. As a result, the front-side conversion layer 84 generates heat, the generated heat is transferred to the thermally expansive layer 12, and the thermally expandable material foams and expands. As a result, as illustrated in FIG. 17B, the area of the thermally expansive layer 12 of the formable resin sheet 10 on which the front-side conversion layer 84 is printed distends and swells. In this step, the base 11 may not be deformed.

Third, the formable resin sheet 10 is conveyed to the printing device with the front surface of the sheet 10 facing upward, and a color image (color ink layer 81) is printed on the front surface of the formable resin sheet 10 using the printing device (Step S23). In this case, in the present embodiment, the convex portion 12d is formed on the formable resin sheet 10 at a stage where color printing is performed. Accordingly, for example, a printing device such as a flexographic printing device may be used, instead of the printing device 40 illustrated in FIG. 7, in accordance with the shape of the convex portion 12d. Specifically, a printing device for cyan C, a printing device for magenta M, a printing device for yellow Y, and a printing device for black K respectively print images of cyan C, magenta M, yellow Y, and black K on the front surface of the formable resin sheet 10 in accordance with the designated color image data. As a result, as illustrated in FIG. 17C, the color ink layer 81 is formed.

Fourth, the thermal conversion layer 82 is printed on the back surface of the formable resin sheet 10 using the printing device (step S24). The thermal conversion layer 82 is a layer formed of an ink containing the electromagnetic wave-heat conversion material, for example, a foaming ink containing carbon black. The printing device performs printing on the back surface of the formable resin sheet 10 in accordance with the designated foaming data. As a result, as illustrated in FIG. 17D, the thermal conversion layer 82 is formed on the back surface of the formable resin sheet 10. Also in this step, the convex portion 12d is formed on the formable resin sheet 10. Thus, a suitable printing device such as, for example, a flexographic printing device may be selected, in accordance with the shape of convex portion 12d, instead of the printing device 40 illustrated in FIG. 7, and printing may be performed using such a suitable printing device.

Fifth, the formable resin sheet 10 on which the thermal conversion layer 82 is printed is conveyed to the expansion device 50 such that the back surface of the sheet 10 faces upward. In the expansion device 50, the emitter 51 emits an electromagnetic wave to the conveyed formable resin sheet 10 (step S25). Specifically, in the expansion device 50, the emitter 51 emits the electromagnetic wave to the back surface of the formable resin sheet 10. The thermal conversion material contained in the thermal conversion layer 82 printed on the back surface of the formable resin sheet 10 absorbs the emitted electromagnetic wave and generates heat. As a result, the heat generated by the thermal conversion layer 82 is transferred to the thermally expansive layer 12, and the thermally expandable material foams and expands. As a result, as illustrated in FIG. 17E, the area of the thermally expansive layer 12 of the formable resin sheet 10 on which the thermal conversion layer 82 is printed distends and swells. The base 11 is pulled by force due to the distention of the thermally expansive layer 12 and thus deformed.

In the present embodiment, as in the above-described embodiment, the thermal conversion layer is formed on the formable resin sheet 10 by printing and an electromagnetic wave is emitted to the thermal conversion layer, thereby making it possible to easily deform the thermal conversion layer into a desired shape to produce the shaped article 22. In addition to this, after at least a portion of the thermally expansive layer 12 is distended using the front-side conversion layer 84, the base 11 can be deformed using the thermal conversion layer 82. As a result, a portion of the front surface of the switch 35 is embossed, and the shaped article 22 further exhibits an effect of making it possible to change the tactile sensation of the shaped article 22. Also, the use of the front-side conversion layer 84 makes it possible to distend a range of shaped objects that can be formed on the front surface of the shaped article 22.

### Embodiment 5

A formable resin sheet 15 according to Embodiment 5 is described with reference to the drawings. The formable resin sheet 15 according to Embodiment 5 is different from the above-described embodiment in that the formable resin sheet 15 includes a first film 16 that covers a second surface (back surface) of the formable resin sheet 15 that is a surface on which the thermal conversion layer 82 is formed. Components that are common to Embodiments 1 and 5 are assigned the same reference signs, and detailed descriptions thereof are omitted.

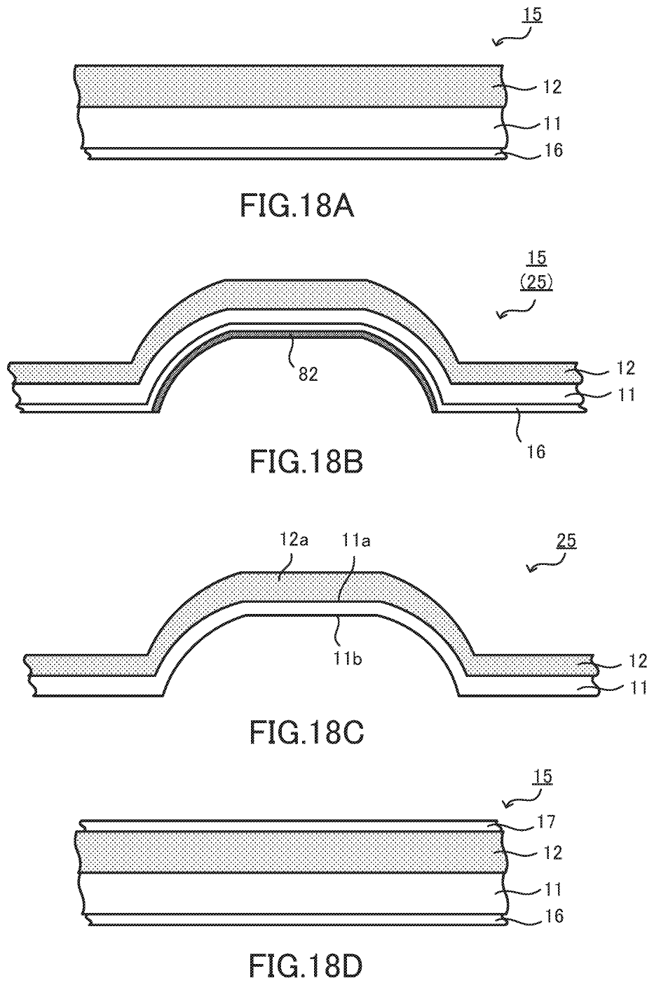

As illustrated in FIG. 18A, the formable resin sheet 15 includes the base 11, the thermally expansive layer 12, and the first film 16 provided on the back surface of the base 11. The first film 16 is provided in order to remove the thermal conversion layer after distending the thermally expansive layer 12. Thus, if the first film 16 is provided at least on the area of the back surface of the base 11 on which the thermal conversion layer 82 is formed, the first film 16 may be provided on the whole or a portion of the back surface of the base 11. Also, the first film 16 is peelably adhered to the base 11. A publically well-known resin film may be used as the first film 16, and the first film 16 is, for example, a film made of a resin selected from polyethylene, polyvinyl alcohol, polypropylene, polyvinyl chloride, a copolymer of these compounds and the like. For example, a film made of ethylene-vinyl alcohol copolymer is used as the first film 16.

When the formable resin sheet 15 is produced, before or after the process of forming the thermally expansive layer 12 illustrated in FIG. 2B, the resin film is provided on the back surface of the base 11 through a publically well-known method such as thermocompression bonding.

Also, FIG. 18B illustrates the state in which the thermally expansive layer 12 of the formable resin sheet 15 is distended using the thermal conversion layer 82. As illustrated in FIG. 18B, the thermal conversion layer 82 is provided on an area of the first film 16 on which the base 11 is to be deformed by distending the thermally expansive layer 12. Also, as illustrated in FIG. 18C, after the deformation of the base 11, the first film 16 is removed from the base 11. As a result, the heat conversion layer 82 together with the first film 16 is removed from the shaped article 25 of the present embodiment.

A method for producing a shaped article of the present embodiment is described with reference to the flowchart of Embodiment 1 illustrated in FIG. 9. The thermal conversion layer 82 is formed on the first film 16 in step S2 of forming the thermal conversion layer 82. Also, a process of removing the first film 16 from the base 11 is further performed after step S3.

Also, in a case in which thermal conversion layers are formed on both surfaces of the formable resin sheet as in Embodiment 4, as illustrated in FIG. 18D, a second film 17 may be further provided on the front surface of the formable resin sheet 15. In a case in which the color ink layer 81 is formed on the thermally expansive layer 12, it is preferable to perform the step of removing the second film 17 after distending the thermally expansive layer 12 using the front-side conversion layer 84 and before the step of forming the color ink layer 81. In the present embodiment, the formable resin sheet 15 includes at least one of the first film 16 and the second film 17 depending on whether the formed thermal conversion layer is removed.

In the present embodiment, the formable resin sheet 15 includes at least one of the first film 16 and the second film 17, thereby making it possible to remove the thermal conversion layer (thermal conversion layer 82, front-side conversion layer 84) after distending the thermally expansive layer 12. In particular, in a case in which the thermal conversion layer contains carbon, the thermal conversion layer may affect the appearance of the shaped article 25. For example, the thermal conversion layer may make a color of the shaped article 25 dull. In this embodiment, since the thermal conversion layer can be removed after the use of the thermal conversion layer, it is possible to prevent the thermal conversion layer from affecting the color of the shaped article 25.

The above-described embodiments can be variously modified and applied. For example, it is possible to combine the features of the respective embodiments. As one example, the configuration of Embodiment 1 in which the color ink layers 81 and 83 are provided on the front surface and the back surface of the shaped article 20 can be also combined with the sticker 60 of Embodiment 3. Also in Embodiment 4, the upper sheet 38 can be omitted as in the modified example of Embodiment 1, and the thermal conversion layer 82 can be made to have the function of the upper contact portion 39. Also, combinations other than the above-described combinations are possible.

Also, in Embodiment 1 described above, the thermal conversion layer 82 is formed on the back surface of the formable resin sheet 10 and the base 11 is formed. However, the present disclosure is not limited to this, and the base 11 can be formed by forming the thermal conversion layer 82 on the front surface of the formable resin sheet 10.

In Embodiment 1 described above, the electronic device 30 includes the shaped article 20 as a decorative cover for the inputter 33. However, the present disclosure is not limited to this. The electronic device 30 can also include the shaped articles 20 and 22 displaced in portions other than the inputter 33. For example, the shaped objects 20 and 22 can be also used for a decoration portion of the electronic device 30.

Also, a layer for enhancing the adhesiveness between the base 11 and the thermally expansive layer 12 may be provided between the base 11 and the thermally expansive layer 12. Also, the thermally expansive layer 12 may have, on the outmost surface, a layer required in accordance with a printing method. For example, the thermally expansive layer 12 may further include an ink receiving layer for improving the fixing of an ink in a case in which the thermally expansive layer is printed by an inkjet printing method. Similarly, the base 11 may also include a layer that is required in accordance with a printing method and is located on the outmost surface of the base (the lower surface of the base 11 illustrated in FIG. 1), for example, an ink receiving layer.

The switch, the electronic device, the sticker, or the lighting device, which is described above, is an example of a product including the shaped article 20, and products according to the present disclosure are not limited to the products of the above-described embodiments.

Also, the drawings used in the respective embodiments are merely used for illustrating each embodiment. Accordingly, the thicknesses of the respective layers of the formable resin sheet should not be restrictively interpreted as being formed in the ratio as illustrated in the drawings. Also, the term relating to the formable resin sheet and the shaped article, “front” or “back”, does not limit the use of the formable resin sheet and the shaped article.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2017-254740, filed on Dec. 28, 2017, and Japanese Patent Application No. 2018-236129, filed on Dec. 18, 2018, the entire disclosure of which is incorporated by reference herein.

### INDUSTRIAL APPLICABILITY

The present disclosure is applicable to a formable resin sheet using a thermally expandable material that foams and distends in accordance with an amount of heat absorbed by the material, a shaped article using the same, a method for producing a shaped article, and a product.

### REFERENCE SIGNS LIST

10, 15 Formable resin sheet
11 Base
11a, 11d, 12a, 12d, 38a Convex portion
11b, 38b Concave portion
12 Thermally expansive layer
16 First film
17 Second film
20, 22, 25 Shaped article
30 Electronic device
31 Display
32 Display panel
33 Inputter
34, 35 Switch
36 Circuit board
37 Lower contact portion
37a, 37b Contact pad
38 Upper sheet
39 Upper contact portion
40 Printing device
41 Plate cylinder
42 Blanket
43 Ink roller
44 Water roller
45 Impression cylinder
50 Expansion device
51 Emitter
52 Reflector plate
53 Temperature sensor
54 Cooling unit
55 Housing
60 Sticker
61 Adhesive layer
62 Peeling sheet
70 Lighting device
71 Lampshade
72 Lamp stand
73 Pedestal
74 Support rod
76, 77 Frame
81, 83 Color ink layer
82 Thermal conversion layer
84 Front-side conversion layer

1. A formable resin sheet comprising:
a base; and
a thermally expansive layer that contains a thermally expandable material and is formed on one surface of the base,
wherein when the thermally expansive layer is expanded, the base is deformed with expansion of the thermally expansive layer, such that the base is deformed in an embossed shape, and a deformation amount of the base is greater than an expansion height of the thermally expansive layer.

2. The formable resin sheet according to claim 1, wherein a thickness of the base is greater than or equal to a thickness of the thermally expansive layer.

3. The formable resin sheet according to claim 1, wherein the base is made of a thermoplastic resin.

4. The formable resin sheet according to claim 1, further comprising a film that is provided such that the film covers at least a portion of at least one of the thermally expansive layer and another surface of the base.

5. A method for manufacturing a shaped article, the method comprising:
forming, on at least one surface of a formable resin sheet, a thermal conversion layer to convert electromagnetic waves into heat, the formable resin sheet including a base and a thermally expansive layer that contains a thermally expandable material and is formed on one surface of the base; and
emitting the electromagnetic waves to the thermal conversion layer to cause the thermally expansive layer to expand,
wherein when the thermally expansive layer is expanded, the base is deformed with expansion of the thermally expansive layer, such that the base is deformed in an embossed shape, and a deformation amount of the base is made to become greater than an expansion height of the thermally expansive layer.

6. The method according to claim 5, wherein a thickness of the base is greater than or equal to a thickness of the thermally expansive layer.

7. The method according to claim 5, wherein the base is made of a thermoplastic resin.

8. The method according to claim 5, wherein:
the formable resin sheet further comprises a film that is provided such that the film covers at least a portion of at least one of the thermally expansive layer and another surface of the base, and
the thermal conversion layer is formed on the film.

9. A shaped article comprising:
a thermally expansive layer that is located on one surface of a base and contains a thermally expandable material,
wherein:
at least a portion of the thermally expansive layer is expanded,
an area of the base in which the thermally expansive layer is expanded is formed into an embossed shape, and
a deformation amount of the area of the base is greater than an expansion height of the thermally expansive layer.

10. A product comprising:
the shaped article according to claim 9.

11. A switch comprising:
the shaped article according to claim 9;
a lower contact portion disposed to oppose another surface of the base and to oppose the area formed into the embossed shape; and
an upper contact portion provided on the area at the another surface of the base.

12. The switch according to claim 11, further comprising an upper sheet, wherein the upper contact portion is provided on the another surface of the base via the upper sheet.

13. The switch according to claim 11, wherein:
a thermal conversion layer that converts electromagnetic waves into heat is provided on the area, and
the thermal conversion layer functions as the upper contact portion.

14. The switch according to claim 11, wherein:
a thermal conversion layer that converts electromagnetic waves into heat is provided on the area, and
the upper contact portion is provided on the thermal conversion layer.

15. An electronic device comprising the switch according to claim 11.

16. A sticker comprising:
the shaped article according to claim 9; and
an adhesive layer provided on another surface of the base.

17. The product according to claim 10, wherein:
the product is a lighting device, and
the product comprises the shaped article as a lampshade.

18. The product according to claim 17, wherein translucency of an area of the shaped article on which the thermally expansive layer is expanded is higher than translucency of an area of the shaped article on which the thermally expansive layer is unexpanded.
